(19) United States
(12) Patent Application Publication
(10) Pub. No.: US 2003/0072162 A1
(43) Pub. Date: Apr. 17, 2003

(54) Luminous light-accumulating bulbs and methods of manufacturing same

(76) Inventor: Jong Young Won, Chungnam (KR)

Correspondence Address: BRINKS HOFER GILSON & LIONE, P.O. BOX 10395, CHICAGO, IL, 60611, US

(21) Appl. No.: 10/179,912

(22) Filed: Jun. 24, 2002

(30) Foreign Application Priority Data
Jun. 23, 2001 (KR) 2001-11287
Jun. 23, 2001 (KR) 10-2001-0036023

(51) Int. Cl. F21V 5/00

(52) U.S. Cl. 362/336

(57) ABSTRACT

A light-accumulating luminous bulb includes a pigment for accumulating light scattered on an inside surface of the bulb. A method of making a light-accumulating luminous bulb includes preparing a mixture comprising from about one to about eight weight percent of nitrocellulose, from about five to about fifteen weight percent of camphor, and an organic solvent; combining the mixture with from about seventy-five to about ninety-five weight percent of a pigment for accumulating light, thereby forming a paint; and spraying the paint on an inside surface of a glass sphere to a thickness from about 0.1 mm to about 0.3 mm. The mixed gas is sprayed successively through three minute pipes having different-sized diameters to form film-like membranes.

### RELATED APPLICATIONS

The present application claims the right of foreign priority under 35 U.S.C. § 119 to Applicant's Korean Patent Application Ser. No. ______ (Registered No. 2001-11287) filed Jun. 23, 2001 entitled “Luminous Bulb for Accumulating Light and a Method for Manufacturing,” the entire contents of which are incorporated herein by reference.

### BACKGROUND

The present invention relates to luminous light-accumulating bulbs and to methods for their manufacture. In particular, the present invention relates to luminous light-accumulating bulbs that exhibit faint illumination after the bulb has been turned off.

Typically, complete or substantially complete darkness results when a light source is extinguished, such that if a faint illumination is desired after a bright light source is extinguished (e.g., at night while sleeping), the use of a nightlight or low watt bulb has been necessary. Thus, two separate lamps—a bright lamp and a faint lamp—are required, which proves both inconvenient (e.g., by occupying inordinate dresser space) and expensive.

Attempts to apply light-accumulating films to the inside or outside of a light bulb have been foiled by problems of incomplete application, and facile heat-induced cracking. Thus, attempts to circumvent the need for two separate lamps have focused typically on applying light-accumulating pigments to transparent glass or plastic (e.g., lamp housings) in the vicinity of a bright light source.

To date, paint containing a light-accumulating pigment has been applied to the transparent glass or plastic in an effort to accumulate sunlight during the daytime and light from a bright lamp during the night. The accumulated light is then used to provide a faint lamp that enables discrimination of objects during the night. Representative objects have included electric switches, outlets, lanterns, emergency exit lamps, fire extinguishers, fire alarms, lifesaving equipment, fatigue caps, advertising signboards, vehicle stickers, fishing supplies, and the like, all of which accumulate sunlight and/or bright lamp light which is then used to provide a faint lamp light after the nearby bright light source has been extinguished.

In each of the above-mentioned examples, a pigment-containing paint for accumulating light was simply applied inside or outside of a transparent glass or plastic surface that encased or was located in the vicinity of a bright light source. Heretofore, there has been no example of a pigment-containing paint for accumulating light being scattered directly inside of a bulb, such that a single bulb may be used as both a general light (e.g., when turned on) and a faint lamp (e.g., when turned off).

### SUMMARY

The scope of the present invention is defined solely by the appended claims, and is not affected to any degree by the statements within this summary.

Briefly stated, a method of making a light-accumulating luminous bulb embodying features of the present invention includes preparing a mixture comprising from about one to about eight weight percent of nitrocellulose, from about five to about fifteen weight percent of camphor, and an organic solvent; combining the mixture with from about seventy-five to about ninety-five weight percent of a pigment for accumulating light, thereby forming a paint; and spraying the paint on an inside surface of a glass sphere to a thickness from about 0.1 mm to about 0.3 mm.

A light-accumulating luminous bulb embodying features of the present invention includes a pigment for accumulating light scattered on an inside surface of the bulb.

### BRIEF DESCRIPTION OF SEVERAL VIEWS OF THE DRAWINGS

FIG. 1 shows a cross-sectional view of a light-accumulating luminous bulb embodying features of the present invention.

### DETAILED DESCRIPTION OF THE PRESENTLY PREFERRED EMBODIMENTS

The present invention provides a light-accumulating luminous bulb in which a paint containing a pigment for accumulating light is scattered directly inside of the bulb, such that the bulb may function as both a general bright lamp when turned on, and as a faint lamp when turned off. The paint containing the pigment for accumulating light has a strong adhesive strength, and is spread inside of the bulb moderately thickly to form a membrane.

A method of applying paint to a bulb embodying features of the present invention, which minimizes or prevents cracking or scratching of the layer of paint even though a large quantity of gas may be injected into the bulb, utilizes a spraying device that connects three minute pipes of different-sized diameters. The mixing gas is typically injected at low pressure.

The following examples are provided solely by way of illustration, and are not intended to limit the scope of the appended claims or their equivalents. It is to be understood that manifold variations may be made to the representative mixing procedure and/or representative composition described below, all of which lie within the scope of the present invention.

### EXAMPLES

Nitrocellulose and camphor are dissolved in an organic solvent selected from the group consisting of MIBK and MIBA and stirred for more than twelve hours. A pigment for accumulating light (75-95 wt %), preferably a mixture of aluminum oxide, strontium oxide and boron trioxide, is then mixed with the above-mentioned solution and stirred. After stirring for between about half-an-hour and one hour, the solution is spread evenly on the inside of a glass sphere used for making bulbs to a thickness of about 0.1 mm to about 0.3 mm. Next, the sphere is dried, baked (e.g., at about 500 to 550° C.), and evacuated under pressure. Finally, the mixing gas is injected in turn through the three minute spraying pipes of different-sized diameters (e.g., 0.6 mm, 0.8 mm, and 1.0 mm), thereby completing the bulb-manufacturing procedure.

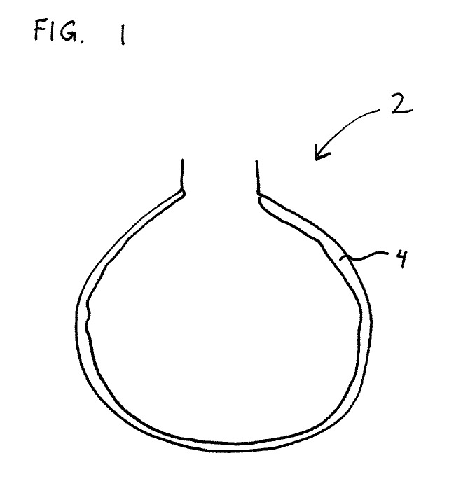

FIG. 1 shows a light-accumulating luminous bulb 2 embodying features of the present invention, in which a paint 4 containing a pigment is spread on an inside surface of the bulb 2. The paint containing a pigment for accumulating light is spread inside of a bulb as described above, such that the bulb emits a bright light when turned on (i.e., acts as a regular bulb) and emits a faint light from the light accumulated by the pigment when turned off. Thus, it is possible to discriminate objects for a duration of time in a state that is neither completely dark nor completely bright. Accordingly, the conventional requirement of using both a bright lamp and a faint lamp separately (e.g., in a bedroom) has been overcome. A bulb embodying features of the present invention fulfills both roles by itself.

Pigments for accumulating light are well known in the art. Nitrocellulose is a first preferred ingredient of a composition embodying features of the present invention, and together with a mixing pigment and camphor forms a film-like membrane inside of a bulb. The amount is chosen to provide a film-like membrane having a desired thickness. Amounts outside the above-mentioned range may prevent formation of a film-like membrane, or may prevent uniformly thick application of the paint. Camphor is a second preferred ingredient for a composition embodying features of the present invention and, when mixed with nitrocellulose and solvent, provides adhesive strength to the film-like membrane formed inside the bulb. In addition, camphor provides flexibility to the membrane, such that the film-like membrane formed by the paint does not crack when the mixed gas is injected. Amounts outside the preferred range may lead to film-like membranes that crack easily due to low adhesive strength, or to the paint being applied prior to formation of the film-like membrane due to high adhesive strength.

Organic solvents are preferred for use in accordance with the present invention. Preferred organic solvents include alcohols and ketones. More preferably, the organic solvent is selected from the group consisting of MIBK, MIBA, and a combination thereof. The preferred organic solvents MIBK and MIBA dissolve the above-mentioned mixture of nitrocellulose and camphor and, more importantly, exhibit excellent pigment dispersal properties.

Though the size of the pigment particles is unrestricted, it is preferred that the particles be ground minutely for about seventy-two hours. Similarly, though the duration of mixing time for the above-mentioned mixture of solution and pigment is unrestricted, it is preferred that the mixture is stirred for sufficient time to disperse the pigment equally throughout.

Methods embodying features of the present invention enable the application of substantially undamaged film-like membranes. When the mixed gas is injected into the bulb, the minute pipes of different-sized diameters (0.6 mm, 0.8 mm, and 1.0 mm) are used in turn for the following reasons. Mixed gas passes through narrow pipe for the first time. Pressure lowers while the gas passes progressively through the broad pipe, thereby maintaining constant spraying pressure and power for spraying the gas equally. This process does not damage the film-like membrane formed in the bulb.

1. A method of making a light-accumulating luminous bulb comprising:
preparing a mixture comprising from about one to about eight weight percent of nitrocellulose, from about five to about fifteen weight percent of camphor, and an organic solvent;
combining the mixture with from about seventy-five to about ninety-five weight percent of a pigment for accumulating light, thereby forming a paint; and
spraying the paint on an inside surface of a glass sphere to a thickness between about 0.1 mm to about 0.3 mm.

2. The invention of claim 1 wherein the organic solvent is selected from the group consisting of MIBK, MIBA, and a combination thereof.

3. The invention of claim 1 wherein the pigment comprises aluminum oxide, strontium oxide and boron trioxide.

4. The invention of claim 2 wherein the pigment comprises aluminum oxide, strontium oxide and boron trioxide.

5. The invention of claim 1 further comprising drying the glass sphere, baking the glass sphere, and evacuating the glass sphere.

6. The invention of claim 2 further comprising drying the glass sphere, baking the glass sphere, and evacuating the glass sphere.

7. The invention of claim 4 further comprising drying the glass sphere, baking the glass sphere, and evacuating the glass sphere.

8. The invention of claim 2 further comprising successively injecting a mixing gas into the glass sphere through a first minute spraying pipe having a diameter of about 0.6 mm, a second minute spraying pipe having a diameter of about 0.8 mm, and a third minute spraying pipe having a diameter of about 1.0 mm.

9. The invention of claim 4 further comprising successively injecting a mixing gas into the glass sphere through a first minute spraying pipe having a diameter of about 0.6 mm, a second minute spraying pipe having a diameter of about 0.8 mm, and a third minute spraying pipe having a diameter of about 1.0 mm.

10. The invention of claim 7 further comprising successively injecting a mixing gas into the glass sphere through a first minute spraying pipe having a diameter of about 0.6 mm, a second minute spraying pipe having a diameter of about 0.8 mm, and a third minute spraying pipe having a diameter of about 1.0 mm.

11. A light-accumulating luminous bulb comprising a pigment for accumulating light scattered on an inside surface of the bulb.

12. The invention of claim 1 1 wherein the pigment for accumulating light comprises a mixture of aluminum oxide, strontium oxide and boron trioxide.

13. The invention of claim 12 further comprising nitrocellulose and camphor on the inside surface of the bulb.
